(19) United States
(12) Patent Application Publication
(10) Pub. No.: US 2024/0062747 A1
(43) Pub. Date: Feb. 22, 2024

(54) DILATED CONVOLUTIONS AND GATING FOR EFFICIENT KEYWORD SPOTTING

(71) Applicant: SONOS VOX FRANCE SAS, Paris (FR)

(72) Inventors: Alice Coucke, Paris (FR); Mohammed Chlieh, Paris (FR); Thibault Gisselbrecht, Paris (FR); David Leroy, Paris (FR); Mathieu Poumeyrol, Paris (FR); Thibaut Lavril, Paris (FR)

(21) Appl. No.: 18/456,941

(22) Filed: Aug. 28, 2023

Related U.S. Application Data
(63) Continuation of application No. 17/549,253, filed on Dec. 13, 2021, now Pat. No. 11,741,948.
Application No. 17/549,253 is a continuation of application No. 16/685,135, filed on Nov. 15, 2019, now Pat. No. 11,200,889.

(30) Foreign Application Priority Data
Nov. 15, 2018 (EP) 18306501.0

(51) Int. Cl. G10L 15/16; G10L 15/06; G10L 15/22

(52) U.S. Cl. CPC G10L 15/16; G10L 15/063; G10L 15/22; G10L 2015/088

(57) ABSTRACT

A method for detection of a keyword in a continuous stream of audio signal, by using a dilated convolutional neural network, implemented by one or more computers embedded on a device, the dilated convolutional network comprising a plurality of dilation layers, including an input layer and an output layer, each layer of the plurality of dilation layers comprising gated activation units, and skip-connections to the output layer, the dilated convolutional network being configured to generate an output detection signal when a predetermined keyword is present in the continuous stream of audio signal, the generation of the output detection signal being based on a sequence of successive measurements provided to the input layer, each successive measurement of the sequence being measured on a corresponding frame from a sequence of successive frames extracted from the continuous stream of audio signal, at a plurality of successive time steps.

### CROSS REFERENCE TO RELATED APPLICATIONS

This application claims priority as a continuation under 35 U.S.C. § 120 to U.S. application Ser. No. 17/549,253 filed on Dec. 13, 2021, which is a continuation of Ser. No. 16/685,135, filed on Nov. 15, 2019, which claims priority under 35 U.S.C. § 119 to following Europe Patent Application No. 18306501.0, filed on Nov. 15, 2018, the contents of each of which are incorporated herein by reference in their entireties.

### TECHNICAL FIELD OF THE INVENTION

This invention relates to the field of using neural networks to automatically recognize speech, and, more precisely, to automatically detect pre-defined keywords in a continuous stream of audio signal.

### BACKGROUND

Traditional approaches to keyword spotting either require important memory resources and fail at capturing large patterns with reasonably small models, or require such important computational resources that they cannot be implemented on a low-resource device.

Therefore, there is a need for an effective on-device keyword spotting method, providing real-time response and high accuracy for good user experience, while limiting memory footprint and computational cost.

### SUMMARY OF THE INVENTION

The present invention provides a method for detection of a keyword in a continuous stream of audio signal, by using a dilated convolutional neural network, implemented by one or more computers embedded on a device, the dilated convolutional network comprising a plurality of dilation layers, including an input layer and an output layer, each layer of the plurality of dilation layers comprising gated activation units, and skip-connections to the output layer, the dilated convolutional network being configured to generate an output detection signal when a predetermined keyword is present in the continuous stream of audio signal, the generation of the output detection signal being based on a sequence of successive measurements provided to the input layer, each successive measurement of the sequence being measured on a corresponding frame from a sequence of successive frames extracted from the continuous stream of audio signal, at a plurality of successive time steps.

According to these provisions, it is possible to embed on a low power and performance limited device the necessary computation and memory resources to implement a dilated convolutional network and use it for keyword detection applications.

According to an embodiment, the invention comprises one or more of the following features, alone or in combination.

According to an embodiment, the dilation convolutional neural network comprises 24 layers.

According to an embodiment, the successive measurements are acoustic features measured on successive frames extracted from the audio stream every 10 ms, each frame having a 25 ms duration.

According to an embodiment, the acoustic features measured on successive frames are 20 dimensional log-Mel filterbank energies.

According to an embodiment, the dilated convolutional neural network is configured to compute, at a time step, a dilated convolution based on a convolution kernel for each dilation layer, and to put in a cache memory the result of the computation at the time step, so that, at a next time step, the result of the computation is used to compute a new dilated convolution based on a shifted convolution kernel for each dilation layer.

According to these provisions, using the result of the computation at a time to compute the dilation convolution at a next time allows reducing the amount of floating point operations per second to a level compatible with the requirement of embedding the computer implemented dilated convolutional neural network on a small device.

According to another aspect, the invention provides a computer implemented method for training a dilated convolutional neural network, the dilated convolutional neural network being implemented by one or more computers embedded on a device, for keyword detection in a continuous stream of audio signal, the method comprising a data set preparation phase followed by a training phase based on the result of the data set preparation phase, the data set preparation phase comprising a labelling step comprises a step of associating a first label to successive frames which occur inside a predetermined time period centred on a time step at which an end of the keyword occurs, and in associating a second label to frames occurring outside the predetermined time period and inside a positive audio sample containing a formulation of the keyword, the positive audio samples comprising a first sequence of frames, the frames of the first sequence of frames occurring at successive time steps in between the beginning of the positive audio sample and the end of the positive audio sample.

According to an embodiment, the invention comprises one or more of the following features, alone or in combination.

According to an embodiment, the labelling step further comprises a step of associating the second label to frames inside a negative audio sample not containing a formulation of the keyword, the negative audio sample comprising a second sequence of frames, the frames of the second sequence of frames occurring at successive time steps in between a beginning time step of the positive audio sample and an ending time step of the positive audio sample.

According to these provisions, it is possible to train a more accurate model, and therefore more accurate detection results when using the computer implemented dilated convolutional network (DCNN) for keyword detection.

According to an embodiment the first label is a 1, and the second label is a 0.

According to an embodiment, the end of the keyword is detected using a voice activity detection computer implemented algorithm.

According to an embodiment, a width of the predetermined time period is optimised during a further step of validation based on a set of validation data.

According to an embodiment, during the training phase, the training of the dilated convolutional neural network is configured to learn only from the frames included in the second sequence of frames and from the frames which are associated to the first label and which are included in the first sequence of frames, and not to learn from the frames which are included in the first sequence frames and which are associated to the second label.

According to these provisions, the efficiency of the method is further improved, allowing even better accuracy in the model, and better accuracy in the detection results when using the computer implemented dilated convolutional network (DCNN) for keyword detection.

According to another aspect, the invention provides a method for detection of a keyword in a continuous stream of audio signal, by using a dilated convolutional neural network, implemented by one or more computers embedded on a device, the dilated convolutional network comprising a plurality of dilation layers, including an input layer and an output layer, each layer of the plurality of dilation layers comprising gated activation units, and skip-connections to the output layer, the dilated convolutional network being configured to generate an output detection signal when a predetermined keyword is present in the continuous stream of audio signal, the generation of the output detection signal being based on a sequence of successive measurements provided to the input layer, each successive measurement of the sequence being measured on a corresponding frame from a sequence of successive frames extracted from the continuous stream of audio signal, at a plurality of successive time steps, wherein the dilated convolutional network is trained according to the computer implemented method for training a dilated convolutional neural network, of the invention.

### BRIEF DESCRIPTION OF THE DRAWINGS

The foregoing and other purposes, features, aspects and advantages of the invention will become apparent from the following detailed description of embodiments, given by way of illustration and not limitation with reference to the accompanying drawings, in which the same reference refer to similar elements or to elements having similar functions, and in which:

FIG. 1 schematically represents a view of an embodiment of a dilated convolutional neural network at a given time step;

FIG. 2 schematically represents a view of an embodiment of activation gated units and skip-connections for a dilated convolutional neural network;

FIGS. 3a and 3b illustrates an embodiment of a labelling method to prepare training data sets.

### DETAILED DESCRIPTION OF THE INVENTION ACCORDING TO AN EMBODIMENT

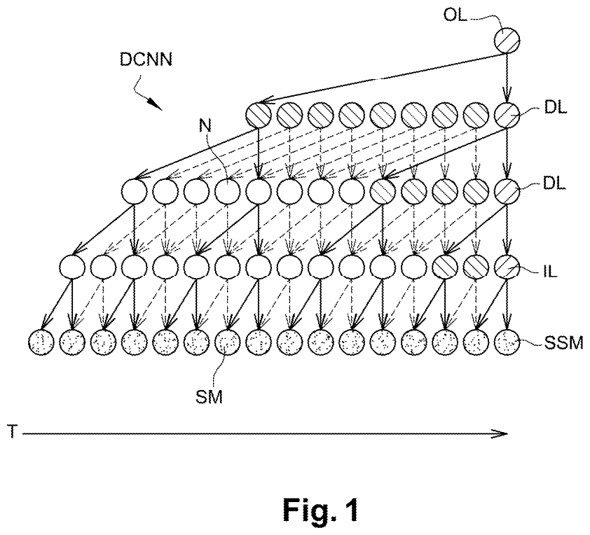

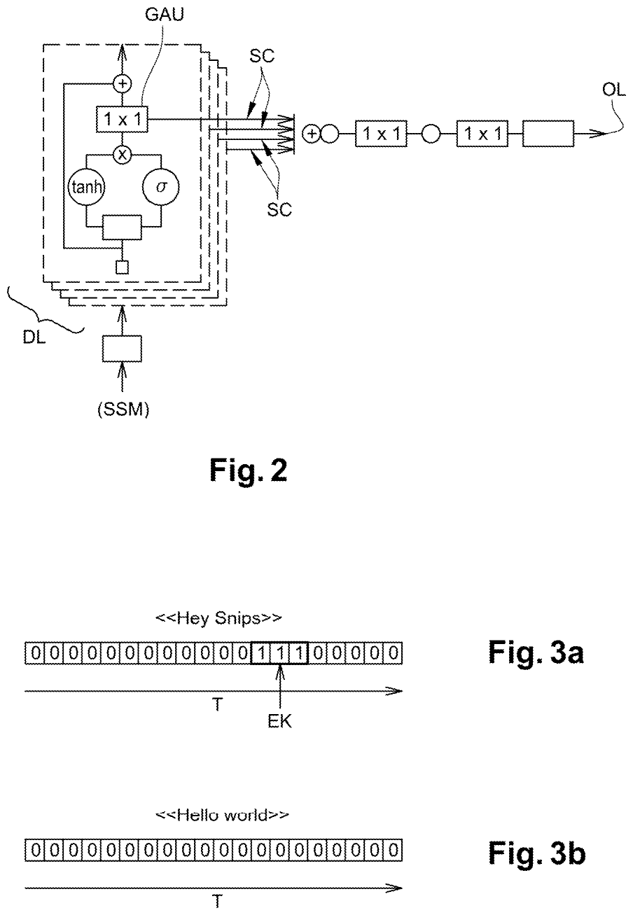

An embodiment of a computer implemented method for keyword detection in a continuous stream of audio signal, using a computer implemented dilated convolutional network, will be described in reference to FIGS. 1 and 2.

According to an embodiment illustrated in FIG. 1, a continuous audio-stream is fragmented into a sequence SSM of successive measurements SM, each successive measurement SM resulting from the measurement of one or more acoustic features on a frame extracted from the continuous audio stream. According to an embodiment, the acoustic features are 20 dimensional log-Mel filterbank energies measured on successive frames extracted from the audio stream every 10 ms, each frame having a 25 ms duration.

As illustrated in FIG. 1, the sequence SSM of successive measurements SM is provided as an input to a computer implemented dilated convolutional neural network DCNN.

FIG. 1 illustrates the configuration at a given time step of the inference process for keyword detection, with a given number of successive measurements SM being provided as input to the dilated convolutional neural network DCNN. At a next time step of the inference process for keyword detection, a new successive measurement SM is introduced in the sequence provided as input, pushing the sequence in the direction opposite to the time direction T represented on FIG. 1, the time direction T being directed towards the future.

According to an embodiment illustrated in FIG. 1, as it is well-known from the one skilled in the art, the computer implemented dilated convolutional network comprises a plurality of dilation layers DL, including an input layer IL and an output layer OL, and it is configured to implement, at each successive time steps of the process, dilated convolution of the sequence SSM of successive measurements SM which is provided, at each given time step of the process, to the input layer IL of the computer implemented dilated convolutional network.

According to an embodiment illustrated at FIG. 2, as it is well-known from the one skilled in the art, each layer of the plurality of dilation layers DL further comprises gated activation units GAU, and skip-connections SC to the output layer OL.

According to an embodiment of the dilated convolutional network DCNN is configured to generate an output detection signal when a predetermined keyword is present in the continuous stream of audio signal, the generation of the output detection signal being based on the result of the dilated convolution of the sequence SSM of successive measurements SM provided to the input layer IL, the result of the dilated convolution being transformed by operation of gated activation units GAU and of skip-connections SC to contribute to the generation of the output detection signal. Skip connections are introduced to speed up convergence address the issue of vanishing gradients posed by training of models of higher depth. Each layer yields two outputs: one is directly fed to the next layer as usual, but the second one skips it. All skip-connections outputs are then summed into the final output of the network. Without these bypassing strategies, one could not train deeper architectures, as required by the keyword detection application.

The gated activation units are a combination of tanh and sigmoid activations. Sigmoid activation filter acts like a gate for the tanh activation filter, depending on how important is the output of the tanh filter.

The computer implemented dilated convolutional network DCNN is configured to run in a streaming fashion during inference process for detection of keyword. When receiving a new input frame at a next time step, the result of the dilated convolution computation at a previous time step is used to compute a new dilated convolution based on a shifted convolution kernel for each dilation layer. This is possible because convolution kernels of each dilation layer are shifted one time step at a time, or a few time steps at a time, but in any case the “stride”, or the number of time steps the kernel is shifted at a time, is usually smaller than the kernel size, so that two subsequent convolution kernels overlap. This cached implementation allows reducing the amount of Floating Point Operations per Second (FLOPS), so that the level of computing resources required by the inference process for keyword detection task is compatible with technical constraints imposed by embedding of the computer implemented dilated convolutional network DCNN on a low power and performance limited device. Indeed, using a dilated convolutional network architecture for keyword detection implies technically dealing with a deeper model dealing with a larger number of parameters, therefore it is important for this specific application to be able to reduce as indicated the amount of FLOPS.

Before using the computer implemented dilation convolutional network DCNN in an inference mode for keyword detection, it is necessary to train the dilation convolutional network DCNN so that it builds an internal model adapted to the keyword (s) to be detected during the inference process.

According to an aspect, the invention also relates to a computer implemented method for training a dilated convolutional neural network (DCNN). The method comprises a data set preparation phase, followed by a training phase based on the result of the data set preparation phase, the data set preparation phase comprising the following steps:
collect two sets of training data comprising respectively to types of audio samples of varying duration. A first type of audio samples, that will be denoted positive audio samples, the positive audio samples corresponding to the utterance by someone of the predetermined keyword(s); for example an audio sample corresponding to someone saying the keyword to be detected, “Hey SNIPS” for example, as illustrated in FIG. 3a, with silence at the beginning and the end, will be denoted as “positive sample”. A second type of audio samples, that will be denoted negative audio samples, the negative audio samples corresponding to the utterance by someone of a random sentence, “Hello world” for example, as illustrated in FIG. 3b.
to be processed by the computer implemented dilated convolutional network, the audio samples are respectively divided into sequences of successive frames; according to an embodiment, the frames are of 25 ms duration and overlap by 10 ms with the previous and next frames. Each successive frame corresponds to a portion of the audio sample occurring respectively at one of a sequence of successive time steps.
in the sequence of successive frames corresponding to positive audio samples, automatically detect a frame, for example by using a voice activity detection algorithm, the detected frame corresponding to an end EK of the keyword, and associate a first label, 1 for example as illustrated on FIG. 3a, to all successive frames which occur, in the sequence of successive frames, inside a predetermined time period starting before and ending after the occurrence time step of the detected frame, and associate a second label, 0 for example, to each other frame of the sequence of successive frames, corresponding to positive audio samples, which occur outside the predetermined time period.
associate the second label, 0 for example, to each frame of the sequences of successive frames corresponding to negative audio samples, as illustrated on FIG. 3b.

According to these provisions, instead of using an alignment algorithm to find the keyword window that is aligned with the spoken keyword, and to label 1, for example, the frames inside the window, and 0 the frames outside the window, according to the method of the invention, only the frames close to the end of the keyword are labelled 1. The end of the keyword can easily be detected by, for example, a voice activity detection algorithm. Thus, it is possible to train a more accurate model, and therefore to obtain more accurate detection results when using the computer implemented dilated convolutional network DCNN for keyword detection.

In the traditional approach, the model has a tendency to trigger as soon as the keyword starts, whether or not the sample contains only a fraction of the keyword. One advantage of our approach is that the network will trigger near the end EK of keyword, once it has seen enough context.

According to an embodiment of the method, the predetermined time period is centered on the frame corresponding to the end EK of the keyword, the width of the predetermined time period being optimised during a further step of validation tests based on a set of validation data.

According to an embodiment of the method, during the training of the dilated convolutional neural network DCNN, the dilated convolutional neural network DCNN is configured to learn only from the successive frames of the negative audio samples, and from the successive frames of the positive audio samples which are associated to the first label, 1 for example, and not to learn from successive frames of the positive audio samples which are associated to the second label, 0 for example.

According to these provisions, the efficiency of the method is further improved, allowing even better accuracy in the model, and better accuracy in the detection results when using the computer implemented dilated convolutional network DCNN for keyword detection.

1. A computing device comprising:
at least one processor;
at least one non-transitory computer-readable medium; and
program instructions stored on the at least one non-transitory computer-readable medium that are executable by the at least one processor such that the computing device is configured to:
extract, at a plurality of successive time steps, a sequence of successive frames from a stream of audio signal;
measure a sequence of successive measurements, each successive measurement of the sequence measured on a corresponding frame from the sequence of successive frames;
provide the sequence of successive measurements to an input layer of a dilated convolutional neural network (DCNN), wherein the DCNN comprises a plurality of dilation layers including the input layer and an output layer;
based on the sequence of successive measurements provided to the input layer, detect a presence of a predetermined keyword in the stream of audio content; and
based on detecting the presence of the predetermined keyword, generate an output detection signal indicating the presence of the predetermined keyword.

2. The computing device of claim 1, further comprising program instructions that are executable by the at least one processor such that the computing device is configured to:
compute, via the DCNN at a time step, a dilated convolution based on a respective convolution kernel for each dilation layer of the plurality of dilation layers;
store a result of the computation at the time step; and
at a next time step, use the result of the computation to compute, via the DCNN, a new dilated convolution based on a respective shifted convolution kernel for each dilation layer of the plurality of dilation layers.

3. The computing device of claim 1, wherein each frame in the sequence of successive frames has a 25 millisecond duration.

4. The computing device of claim 1, wherein the program instructions that are executable by the at least one processor such that the computing device is configured to measure the sequence of successive measurements comprise program instructions that are executable by the at least one processor such that the computing device is configured to measure acoustic features from the sequence of successive frames extracted from the stream of audio signal.

5. The computing device of claim 4, wherein the program instructions that are executable by the at least one processor such that the computing device is configured to measure the acoustic features from the sequence of successive frames extracted from the stream of audio signal comprise program instructions that are executable by the at least one processor such that the computing device is configured to measure the acoustic features from the sequence of successive frames every 10 milliseconds.

6. The computing device of claim 4, wherein the acoustic features measured from the sequence of successive frames are 20 dimensional log-Mel filterbank energies.

7. The computing device of claim 1, wherein the DCNN comprises 24 dilation layers.

8. A non-transitory computer-readable medium, wherein the non-transitory computer-readable medium is provisioned with program instructions that, when executed by at least one processor, cause a computing device to:
extract, at a plurality of successive time steps, a sequence of successive frames from a stream of audio signal;
measure a sequence of successive measurements, each successive measurement of the sequence measured on a corresponding frame from the sequence of successive frames;
provide the sequence of successive measurements to an input layer of a dilated convolutional neural network (DCNN), wherein the DCNN comprises a plurality of dilation layers including the input layer and an output layer;
based on the sequence of successive measurements provided to the input layer, detect a presence of a predetermined keyword in the stream of audio content; and
based on detecting the presence of the predetermined keyword, generate an output detection signal indicating the presence of the predetermined keyword.

9. The non-transitory computer-readable medium of claim 8, wherein the non-transitory computer-readable medium is also provisioned with program instructions that, when executed by at least one processor, cause the computing device to:
compute, via the DCNN at a time step, a dilated convolution based on a respective convolution kernel for each dilation layer of the plurality of dilation layers;
store a result of the computation at the time step; and
at a next time step, use the result of the computation to compute, via the DCNN, a new dilated convolution based on a respective shifted convolution kernel for each dilation layer of the plurality of dilation layers.

10. The non-transitory computer-readable medium of claim 8, wherein each frame in the sequence of successive frames has a 25 millisecond duration.

11. The non-transitory computer-readable medium of claim 8, wherein the program instructions that, when executed by at least one processor, cause the computing device to measure the sequence of successive measurements comprise program instructions that, when executed by at least one processor, cause the computing device to measure acoustic features from the sequence of successive frames extracted from the stream of audio signal.

12. The non-transitory computer-readable medium of claim 11, wherein the program instructions that, when executed by at least one processor, cause the computing device to measure the acoustic features from the sequence of successive frames extracted from the stream of audio signal comprise program instructions that, when executed by at least one processor, cause the computing device to measure the acoustic features from the sequence of successive frames every 10 milliseconds.

13. The non-transitory computer-readable medium of claim 11, wherein the acoustic features measured from the sequence of successive frames are 20 dimensional log-Mel filterbank energies.

14. The non-transitory computer-readable medium of claim 8, wherein the DCNN comprises 24 dilation layers.

15. A method implemented by a computing device, the method comprising:
extracting, at a plurality of successive time steps, a sequence of successive frames from a stream of audio signal;
measuring a sequence of successive measurements, each successive measurement of the sequence measured on a corresponding frame from the sequence of successive frames;
providing the sequence of successive measurements to an input layer of a dilated convolutional neural network (DCNN), wherein the DCNN comprises a plurality of dilation layers including the input layer and an output layer;
based on the sequence of successive measurements provided to the input layer, detecting a presence of a predetermined keyword in the stream of audio content; and
based on detecting the presence of the predetermined keyword, generating an output detection signal indicating the presence of the predetermined keyword.

16. The method of claim 15, further comprising:
computing, via the DCNN at a time step, a dilated convolution based on a respective convolution kernel for each dilation layer of the plurality of dilation layers;
storing a result of the computation at the time step; and
at a next time step, using the result of the computation to compute, via the DCNN, a new dilated convolution based on a respective shifted convolution kernel for each dilation layer of the plurality of dilation layers.

17. The method device of claim 16, wherein each frame in the sequence of successive frames has a 25 millisecond duration.

18. The method of claim 15, wherein measuring the sequence of successive measurements comprises measuring acoustic features from the sequence of successive frames extracted from the stream of audio signal.

19. The method of claim 18, wherein measuring the acoustic features from the sequence of successive frames extracted from the stream of audio signal comprises measuring the acoustic features from the sequence of successive frames every 10 milliseconds.

20. The method of claim 18, wherein the acoustic features measured from the sequence of successive frames are 20 dimensional log-Mel filterbank energies.
